(19) United States
(12) Patent Application Publication
(10) Pub. No.: US 2014/0036433 A1
(43) Pub. Date: Feb. 6, 2014

(54) AIRFLOW GUIDING MEMBER AND ELECTRONIC DEVICE HAVING THE AIRFLOW GUIDING MEMBER

(71) Applicant: ZHI-BIN GUAN, Tu-Cheng (TW)

(72) Inventor: ZHI-BIN GUAN, Tu-Cheng (TW)

(73) Assignee: HON HAI PRECISION INDUSTRY CO., LTD., Tu-Cheng (TW)

(21) Appl. No.: 13/587,952

(22) Filed: Aug. 17, 2012

(30) Foreign Application Priority Data
Aug. 1, 2012 (TW) 101127698

(51) Int. Cl. F24H 9/12; G06F 1/20

(52) U.S. Cl. 361/679.32; 138/37

(57) ABSTRACT

An electronic device includes a circuit board, a number of memory cards installed on the circuit board, and an airflow guiding member installed on the circuit board. The airflow guiding member includes a first side plate and a partition plate. The first side plate and the partition plate cooperatively bound a first airflow channel. The memory cards are received in the first airflow channel. An air inlet is defined in an end of the airflow guiding member and communicating with the first airflow channel. A number of spacing pieces is formed in the air inlet and aligns with the memory cards.

### BACKGROUND

1. Technical Field

The disclosure relates to the electronic devices and, particularly, to an electronic device with an airflow guiding member for guiding airflow.

2. Description of Related Art

Many electronic devices, such as computers or servers, have many electronic components, such as central processing units (CPUs), memory cards, and hard disk drives. The components generate a large amount of heat during operation. The heat needs to be dissipated effectively to ensure the continued proper function of the electronic devices. Many cooling fans and an air duct are installed in the chassis of the electronic device for dissipating the heat of the components. For various reasons, some of the memory cards in the electronic device may be removed and not replaced, leaving empty zones in the electronic device. Heat-dissipating airflows tend to flow through the empty zones with low airflow resistance, rather than flow through the heat generating components in the electronic device. Therefore, the empty zones in the electronic device will possibly decrease heat dissipation efficiency in the electronic device.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric, exploded view of an embodiment of an electronic device, wherein the electronic device includes an airflow guiding member.

FIG. 2 is an enlarged view of the airflow guiding member of FIG. 1.

FIG. 3 is an assembled, isometric view of the electronic device of FIG. 1, showing the electronic device in use.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

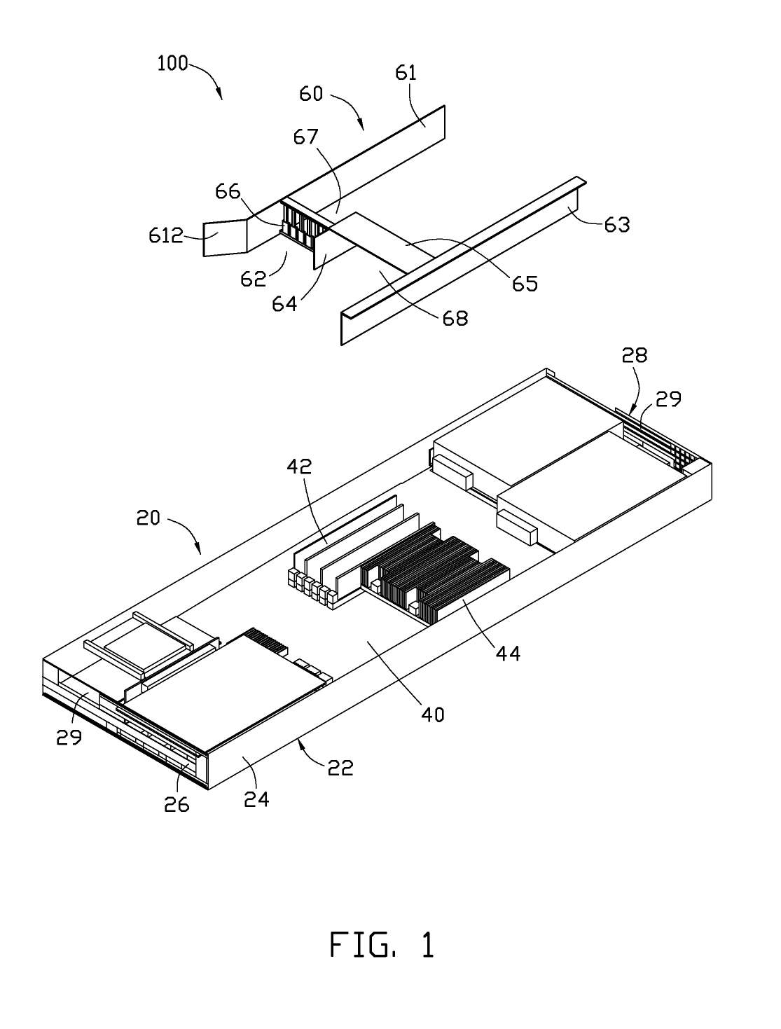

FIG. 1 shows an embodiment of an electronic device 100. The electronic device 100 includes a casing 20, a circuit board 40, and an airflow guiding member 60.

The casing 20 includes a rectangular bottom wall 22, two opposite sidewalls 24 perpendicularly extending up from two opposite sides of the bottom wall 22. A first end wall 26 perpendicularly extends up from a first end of the bottom wall 22, and a second end wall 28 perpendicularly extends up from a second end of bottom wall 22 opposite to the first end wall 26. The first end wall 26 and the second end wall 28 each define a plurality of vents 29.

The circuit board 40 is installed on the bottom wall 22 by screwing or clamping. A plurality of memory cards 42 is installed on the circuit board 40, parallel to the sidewalls 24. A heat sink 44 attached to a central processing unit (not shown) is mounted on the circuit board 40, at a side of the memory cards 42.

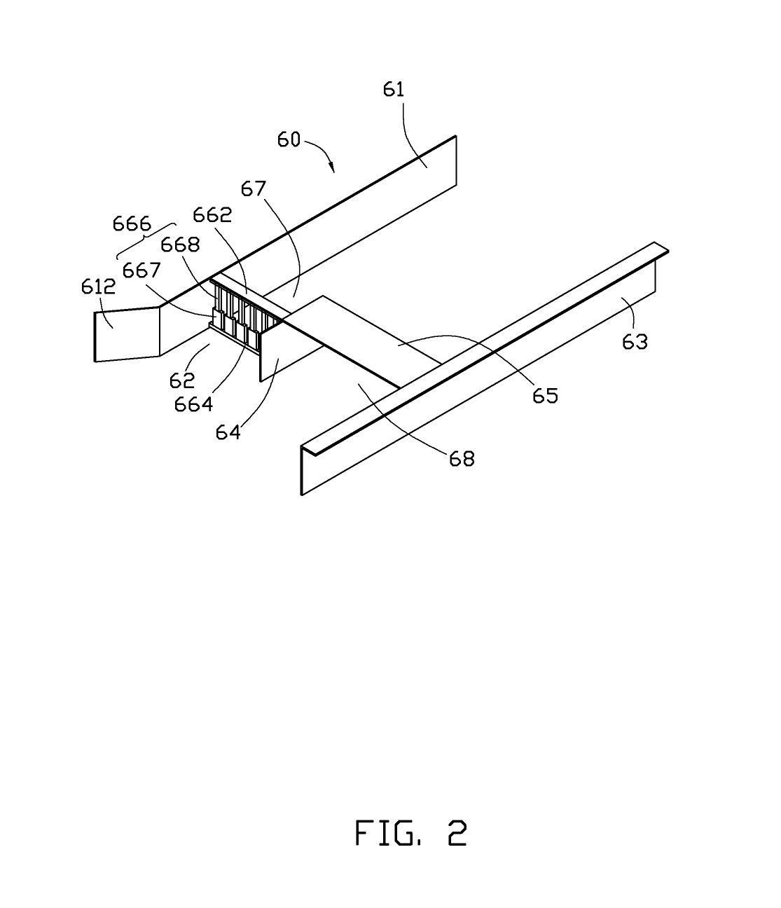

Referring to FIG. 2, the airflow guiding member 60 of the embodiment is shown. The airflow guiding member 60 includes a first side plate 61, a second side plate 63 spaced from and parallel to the first side plate 61, and a partition plate 64 located between the first side plate 61 and a second side plate 63 in a parallel direction. A connecting plate 65 is connected between tops of the partition plate 64 and the second side plate 63. The partition plate 64 and the first side plate 61 cooperatively bound a first airflow channel 67. The partition plate 64 and the second side plate 63 cooperatively bound a second airflow channel 68. An end of the first airflow channel 67 defines an air inlet 62, and a blocking portion 66 is installed in the air inlet 62. The blocking portion 66 includes a connecting bar 662 connected between the top of the partition plate 64 and a top of the first side plate 61, a supporting bar 664 connected between bottoms of the partition plate 64 and the first side plate 61 opposite to the connecting bar 662. In addition, a plurality of spacing pieces 666 are spaced apart and connected between the connecting bar 662 and the supporting bar 664. An airflow guiding plate 612 slantingly extends out from an end of the first side plate 61 adjacent to the air inlet 65, for guiding the airflow. In the embodiment, each spacing piece 666 includes a base 667 extending up from the supporting bar 664, and a blocking pole 668 connected between the base 667 and the connecting bar 662.

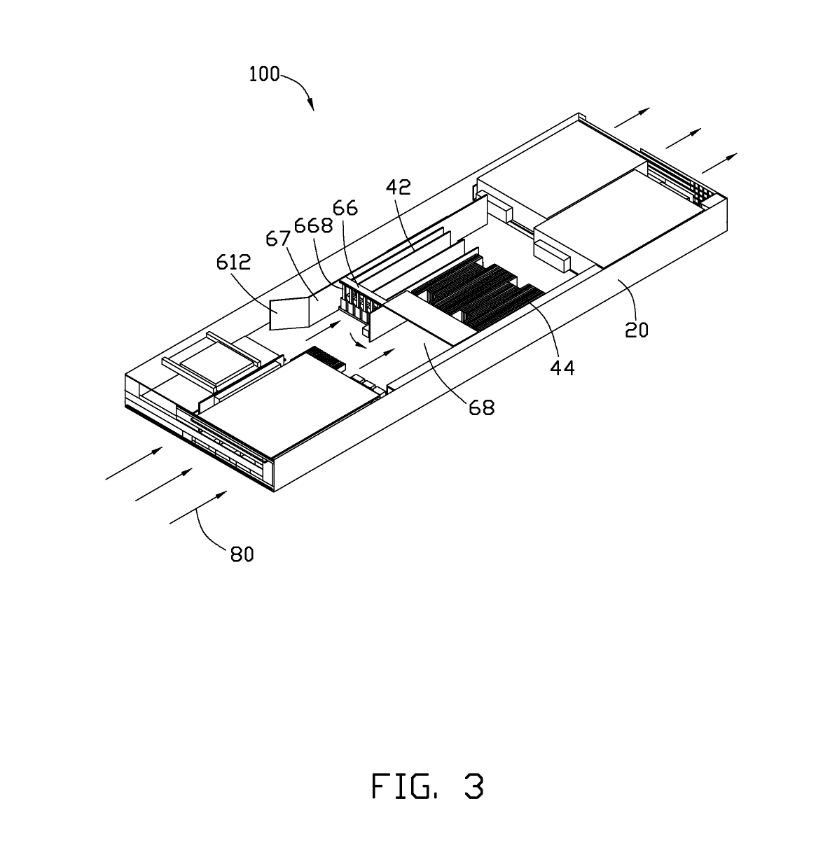

Referring to FIG. 3, the airflow guiding member 60 is installed on the bottom wall 22 by screwing or clamping. The memory cards 42 are received in the first airflow channel 67. The blocking portion 66 is located between the first end wall 26 and the memory cards 42 and adjacent to an end of the memory cards 42. Each blocking pole 668 aligns with the corresponding memory card 42. A width of each blocking pole 668 is greater than a width of the corresponding memory card 42, and a top of each blocking pole 668 is higher than a top of the corresponding memory card 42. The heat sink 44 and the central processing unit are received in the second airflow channel 68.

In use, airflow 80 generated by fans (not shown) enters the casing 20 from the vents 29 of the first end wall 26, and extends through the memory cards 42 and the heat sink 44 and the central processing unit along the first airflow channel 67 and the second airflow channel 68. And then exhausts through the vents 29 of the second end wall 28. Because each blocking pole 668 of the blocking portion 66 has a width and a height respectively greater than a width and a height of the memory card 42. When some of the memory cards 42 are removed from the circuit board 40, resistance to the airflow provided by the blocking poles 668 without memory cards behind are the same as airflow resistance provided by the blocking poles 668 in front of the memory cards 42 installed on the circuit board 40. Therefore, when the airflow guiding member 60 is installed in the casing 20, lower heat dissipation efficiency caused by significant redistribution of airflow 80 through the casing 20 can be avoided. A space in the casing 20 above the airflow guiding member 60 is empty, so it is convenient to install or remove the memory cards or the heat sink when maintenance or replacement of the electronic device 100 is needed.

It is to be understood, however, that even though numerous characteristics and advantages of certain embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An airflow guiding member, comprising:
a first side plate; and
a partition plate, wherein the first side plate and the partition plate cooperatively bound a first airflow channel for receiving a plurality of memory cards, an air inlet is defined in an end of the airflow guiding member and communicating with the first airflow channel, a plurality of spaced spacing pieces is formed in the air inlet and aligns with the memory cards.

2. The airflow guiding member of claim 1, wherein a connecting bar is connected between a top of the first side plate and a top of the partition plate, a supporting bar is connected between a bottom of the first side plate and a bottom of the partition plate opposite to the connecting bar, the spacing pieces are connected between the connecting bar and the supporting bar.

3. The airflow guiding member of claim 2, wherein each spacing piece comprises a base extending up from the supporting bar, and a blocking pole connected between the base and the connecting bar.

4. The airflow guiding member of claim 3, wherein a width of each blocking pole is greater than a width of the corresponding memory card.

5. The airflow guiding member of claim 3, wherein a top of each blocking pole is higher than a top of the corresponding memory card.

6. The airflow guiding member of claim 1, wherein a width of each blocking pole is greater than a width of the corresponding memory card, and a top of each blocking pole is higher than a top of the corresponding memory card.

7. The airflow guiding member of claim 1, further comprising a second side plate at a side of the partition plate opposite to the first side plate, the second side plate and the partition plate cooperatively bound a second airflow channel.

8. An electronic device, comprising:
a circuit board;
a plurality of memory cards installed on the circuit board; and
an airflow guiding member installed on the circuit board and comprising a first side plate, and a partition plate, wherein the first side plate and the partition plate cooperatively bound a first airflow channel, the memory cards are received in the first airflow channel, an air inlet is defined in an end of the airflow guiding member and communicating with the first airflow channel, a plurality of spaced spacing pieces is formed in the air inlet and aligns with the memory cards.

9. The electronic device of claim 8, wherein a connecting bar is connected between a top of the first side plate and a top of the partition plate, a supporting bar is connected between a bottom of the first side plate and a bottom of the partition plate opposite to the connecting bar, the spacing pieces are connected between the connecting bar and the supporting bar.

10. The electronic device of claim 9, wherein each spacing piece comprises a base extending up from the supporting bar, and a blocking pole connected between the base and the connecting bar.

11. The electronic device of claim 10, wherein a width of each blocking pole is greater than a width of the corresponding memory card.

12. The electronic device of claim 10, wherein a top of each blocking pole is higher than a top of the corresponding memory card.

13. The electronic device of claim 8, wherein a width of each blocking pole is greater than a width of the corresponding memory card, and a top of each blocking pole is higher than a top of the corresponding memory card.

14. The electronic device of claim 8, further comprising a heat sink installed on the circuit board, wherein the airflow guiding member further comprises a second side plate at a side of the partition plate opposite to the first side plate, the second side plate and the partition plate cooperatively bound a second airflow channel for receiving the heat sink.
